(19) United States
(12) Patent Application Publication
(10) Pub. No.: US 2008/0017068 A1
(43) Pub. Date: Jan. 24, 2008

(54) Liquid proofing/liquid repellent agent

(76) Inventors: Brian V. Sokol, Vermilion, OH (US); David A. Lupyan, Chagrin Falls, OH (US)

Correspondence Address: FAY SHARPE LLP, 1100 SUPERIOR AVENUE, SEVENTH FLOOR, CLEVELAND, OH, 44114, US

(21) Appl. No.: 11/879,428

(22) Filed: Jul. 17, 2007

Related U.S. Application Data
(60) Provisional application No. 60/832,018, filed on Jul. 18, 2006.

(51) Int. Cl. C09D 4/00; C08L 91/06

(52) U.S. Cl. 106/271

(57) ABSTRACT

A solution to protect surfaces including nano particles of wax, solvent and a liquid repellent agent.

The present invention claims priority on U.S. Provisional Patent Application Ser. No. 60/832,018 filed Jul. 18, 2006, which is incorporated herein.

The present invention generally relates to a water repellent and/or waterproofing agent, more particularly to a liquid water repellent and/or waterproofing agent that can be applied to various types of surfaces to inhibit or prevent absorption/adsorption of liquids, and even more particularly to a water repellent and/or waterproofing agent that includes nano-sized wax particles to inhibit or prevent absorption/adsorption of liquids on various types of surfaces.

### BACKGROUND OF THE INVENTION

Water repellents and water proofing agents are commonly used to protect various articles from staining, damage, discoloration and the like. Silicones, siloxanes and various fluoro-acrylate polymers are the predominant materials used in fabric water proofing formulations and have been used since the 1960's to protect fabrics from moisture penetration. These formulations are generally sprayed topically onto a fabric surface, and after air curing or drying, provide effective water repellency to rain, moisture as well as protection against various soils and stains. Various compositions have been applied to textiles and other types of materials in an effort to achieve good repellency when contacted with liquids, such as oils and water. Examples of these various formulations are disclosed in U.S. Pat. No. 3,490,925; U.S. Pat. No. 5,425,804; US 2005/0003219; US 2005/0009963; US 2005/0056805; and US 2005/0229327, all of which are incorporated herein by reference.

The property of water repellency or soil protection is generally measured by means of the initial contact angle of the water droplet as it sits on the fabric surface. Contact angles in the range of 85-100° are generally expected with the application of any conventional waterproofing formulation onto the surface. The higher the contact angle, the greater the expected protection. Contact angles in the range of 110° or greater would be expected to offer superior water repellency and protection.

Conventional fabric water proofing formulations will consistently provide contact angles in the range of 85-110° when applied to fabric surfaces. These water repellent materials coat the fabric surface in such a way that when additional levels of chemical are used, no additional resulting performance benefit can be expected. These materials will usually be effective at their maximum concentration range within a formulation. Furthermore, although these conventional materials may prevent penetration of the liquid “into” the surface, they actually do not prevent the moisture from coming in contact with the surface fibers. As a result, for those liquids that are potentially staining, a stain may still result from the use of a typical water repellent on fabric. Soil or stain release performance of textiles is important to textile consumers. In general, oil-based stains tend to remain in the textile within the textile fibers, which is highly undesirable.

In view of the current state of the art of waterproofing agents, there is a need for a liquid agent that can be applied to textiles to provide improved oil and water repellency in the textile.

### SUMMARY OF THE INVENTION

The present invention is directed to a new solution that can be applied to various types of surfaces to inhibit or prevent absorption/adsorption of liquids and/or other types of staining compounds. In one non-limiting embodiment of the present invention, there is provided a solution that includes nano particles of one or more waxes to enhance the ability of the solution to inhibit or prevent absorption/adsorption of liquids and/or other types of staining compounds on various types of surfaces. Various types of wax can be used. Non-limiting examples of the one or more waxes that can be included in the solution include, but are not limited to, vegetable waxes (e.g., carnauba wax, Japan waxes, bayberry wax, Jojoba oil wax, rice bran wax, candelilla wax, castor wax, esparto wax, ouricury wax, esbal wax, etc.); animal and insect wax (e.g., beeswax, Chinese wax, shellac wax, spermacetic wax, etc.); petroleum waxes (e.g., paraffin wax, microcrystalline wax, polyethylene wax, ester waxes, lanolin or wood wax, Fischer-Tropsch waxes, saponifies waxes, oxide wax, substituted amide waxes, polymerized a-olefin waxes, etc.); and mineral waxes (e.g., montan wax, ozokerite, celesine, peat waxes, ceresin wax, etc.). The particle size of the wax is important so as to not be visible to the naked eye after the solution has been applied and dries on a textile material. In another and/or additional non-limiting embodiment of the present invention, the average particle size of the wax particles in the solution is generally less than about 3-5 microns. As defined herein, nano-sized particles of wax have a size that is less than about 3-5 microns. When the solution is applied and dried on darker materials, the average particle size of the wax is typically less than about 3 microns so as to avoid being seen by the naked eye and/or to reduce light reflection by the wax on the material. In one non-limiting aspect of this embodiment of the present invention, the average particle size of the wax particles in the solution is generally less than about 1 micron. In another and/or additional non-limiting aspect of this embodiment of the present invention, the average particle size of the wax particles in the solution is up to about 0.1 micron. In still another and/or additional non-limiting aspect of this embodiment of the present invention, the average particle size of the wax particles in the solution is up to about 0.05 micron. In yet another and/or additional non-limiting aspect of this embodiment of the present invention, the average particle size of the wax particles in the solution is up to about 0.001 micron. In still yet another and/or additional non-limiting aspect of this embodiment of the present invention, the average particle size of the wax particles in the solution is generally about 0.0000001-0.001 micron. As can be appreciated, the average particle size of the wax particles can be smaller. It has been found that when the average particle size of the wax particles in the solution is no more than about 0.001 micron, the wax particles are essentially invisible to the naked eye, even on black materials. In still another and/or additional non-limiting embodiment of the present invention, the weight percent of nano particles of wax in the new solution is at least about 0.01 weight percent. In one non-limiting aspect of this embodiment, the weight percent of nano particles of wax in the new solution is at least about 0.05 weight percent. In another and/or additional non-limiting aspect of this embodiment, the weight percent of nano particles of wax in the new solution is up to about 20 weight percent. In still another and/or additional non-limiting aspect of this embodiment, the weight percent of nano particles of wax in the new solution is about 0.06-10 weight percent. In still another and/or additional non-limiting aspect of this embodiment, the weight percent of nano particles of wax in the new solution is about 0.08-3 weight percent. The use of nano particles of wax will not cause a haze on black or dark colored fabrics when used at levels of up to 20% by weight. It has also been found that the nano particles of wax can align themselves on an applied surface to create a “wax-barrier” between the liquid droplets and the fiber surface in such a way that the droplets of moisture will reside on the barrier and not penetrate into the body of the fabric to any degree thereby inhibiting or preventing staining of the fabric material under certain conditions. One non-limiting commercial nano particle wax that can be used is TEGO 105.

In one non-limiting aspect of the present invention, the new solution of the present invention can be designed to be applied to a wide variety of materials such as, but not limited to, made and/or including aba, acrylic, Aertex, alpaca, rayon, baize, linen, silk, camel's hair, canvas, cashmere, cotton, felt, flannel, horsehair, leather, mohair, nylon, vinyl, kevlar, acrylic, wool, spandex, suede, polyester, tapis, velvet, pina cloth, and/or the like. The new solution can be applied to clothing (e.g., shirts, caps, shorts, pants, blouses, shoes, gloves, socks, jackets, coats, etc.), sporting equipment (e.g., equipment/clothing bags, golf bags, tennis bags, etc.), carpet, rugs, door mats, furniture, window treatments, curtains, window blinds, place mats, table clothes, linen napkins, etc. As can be appreciated, the new solution can be applied to other items that are desired to be protected from damage and/or staining from the absorption/adsorption of liquid.

In another and/or additional non-limiting aspect of the present invention, the new solution includes nano particles of wax in combination with a non water based solvent. If water is included in the new solution, the weight percent of water is typically less than about 15 weight percent, more typically less than about 5 weight percent, and even more typically less than about 1 weight percent. Non-limiting examples of non water based solvents include, but are not limited to, acetone, tetrahydrofuran (THF), mineral spirits, methanol, ethanol, isopropyl alcohol, formaldehyde, methyl ethyl ketone, ethyl acetate, acetonitrile, N,N-dimethylformamide (DMF), dimethyl sulfoxide (DMSO), hexane, diethyl ether, methylene chloride, linseed oil, carbon tetrachloride, and/or the like. It has also been found that the alignment of the nano particles of wax is at least partially governed by the solvent or solvent system from which they are deposited. For example, an isopropyl alcohol and/or mineral spirit-based solvent, either as a co-blend or neat, results in an effective deposition and alignment of the nano particles of wax on an applied surface. In one non-limiting embodiment of the invention, a majority of the non water based solvent includes mineral spirits. In one non-limiting aspect of this embodiment, at least about 80 weight percent of the non water based solvent includes mineral spirits. In another and/or additional one non-limiting embodiment of the invention, the non water based solvent includes a mixture of mineral spirits and at least one alcohol. In one aspect of this embodiment, the alcohol includes isopropyl alcohol. In still another and/or additional one non-limiting embodiment of the invention, the non water based solvent constitutes a majority weight percent of the new solution. In one non-limiting aspect of this embodiment, the non water based solvent constitutes at least about 70 weight percent of the new solution. In another and/or additional non-limiting aspect of this embodiment, the non water based solvent constitutes at least about 80 weight percent of the new solution. In still another and/or additional non-limiting aspect of this embodiment, the non water based solvent constitutes about 80-99 weight percent of the new solution. In yet another and/or additional non-limiting aspect of this embodiment, the non water based solvent constitutes 85-97 weight percent of the new solution. In still yet another and/or additional non-limiting aspect of this embodiment, the non water based solvent constitutes 90-96 weight percent of the new solution. In yet another and/or additional one non-limiting embodiment of the invention, a majority weight percent of the non water based solvent constitutes a non-polar solvent.

In still another and/or additional non-limiting aspect of the present invention, the new solution includes a liquid repellent agent in combination with nano particles of wax. Non-limiting examples of liquid repellent agents include, but are not limited to, polymers containing phenol-formaldehyde, methacrylic acid, maleic acid, sulfonated fatty acids, and blends of the above; polymers containing fluorochemical residues; siloxanes, silicones; urethane derivatives; fluoroacrylates; esters; acylic amines; oligomers, Teflon, and the like. Specific non-limiting examples of one or more liquid repellent agents than can be included in the new solution include, but are not limited to, phenol formaldehyde polymers or copolymers such as CEASESTAIN and STAINAWAY (from American Emulsions Company, Inc., Dalton, Ga.), MESITOL (from Bayer Corporation, Pittsburgh, Pa.), ERIONAL (from Ciba Corporation, Greensboro, N.C.), INTRATEX (from Crompton & Knowles Colors, Inc., Charlotte, N.C.), STAINKLEER (from Dyetech, Inc., Dalton, Ga.), LANOSTAIN (from Lenmar Chemical Corporation, Dalton, Ga.), and SR-300, SR-400, and SR-500 (from E. I. du Pont de Nemours and Company, Wilmington, Del.); polymers of methacrylic acid such as the SCOTCHGARD FX series carpet protectors (from 3M Company, St. Paul, Minn.); sulfonated fatty acids from Rockland React-Rite, Inc., Rockmart, Ga.); and/or fluorochemical emulsions such as AMGUARD (from American Emulsions Company, Inc., Dalton, Ga.), SOFTECH (from Dyetech, Inc., Dalton, Ga.), LANAPOL (from Lenmar Chemical Corporation, Dalton, Ga.), SCOTCHGARD FC series carpet protectors (from 3M Company, St. Paul, Minn.), NK GUARD (from Nicca U.S.A, Inc., Fountain Head, N.C.), UNIDYNE (from Diakin America, Inc., Decatur, Ala.), ZONYL 555, ZONYL 7950, ZONYL 5180, ZONYL 6885, ZONYL 7910, ZONYL 6700, ZONYL 8300, ZONYL 6991, ZONYL 310, ZONYL NWG N-130 and N-119 (from E. I. du Pont de Nemours and Company, Wilmington, Del.); REPEARL F-8025 (from Mitsubishi International Corporation), ZONYL 8412 and ZONYL RN (from Ciba-Geigy), FLUORAD series, such as FLUORAD FC 129 (from the 3M Company, St. Paul, Minn.), TEFLON RN, TEFLON 8070, and TEFLON 8787 (from Dupont), FOMBLIN FE-20 series of aqueous-based perfluoro polyether microemulsions (from Ausimont USA, Thorofare, N.J.), fluoropolymer emulsion 3310, 3311 and Unidyne.RTM. TG-532 (from Daikin Industries Ltd., Japan), fluoropolymer emulsions NUVA 5006, NUVA LB Liquid, NUVA LC Liquid (from Clariant Corporation, Charlotte, N.C.), fluoropolymer REPEARL F-45 (from Mitsubishi International Corporation, New York), MYAFIX WS and MYAFIX EX.WS (from Peach State Labs, Rome, Ga.), NUVA FT fluorochemical acrylate polymer (from Clariant Corporation), SHAWGUARD 353 fluoroalkyl acrylate copolymer (from Shaw Industries, Inc.), BARTEX TII, BARTEX MAC, both fluoroalkyl acrylate polymers (from Trichromatic Carpets, Inc., Quebec, Canada). It has been found that when nano particles of wax are added to a liquid repellent agent, an increase in the contact angle water repellency not only results, but the droplets of liquid do not come in contact with surface fibers, thereby inhibiting or preventing a stain from occurring. In one non-limiting embodiment of the invention, the weight percent of liquid repellent agent in the new solution is at least about 0.5 weight percent. In another and/or additional non-limiting embodiment of the invention, the weight percent of liquid repellent agent in the new solution is at least about 1 weight percent. In still another and/or additional non-limiting embodiment of the invention, the weight percent of liquid repellent agent in the new solution is at least about 2 weight percent. In yet another and/or additional non-limiting embodiment of the invention, the weight percent of liquid repellent agent in the new solution is up to about 18 weight percent. In still yet another and/or additional non-limiting embodiment of the invention, the weight percent of liquid repellent agent in the new solution is about 3-15 weight percent. In another and/or additional non-limiting embodiment of the invention, the weight percent of liquid repellent agent in the new solution is about 3-8 weight percent. In another and/or additional non-limiting embodiment of the invention, the liquid repellent agent in the new solution includes a fluoro hydrophobic polymer such as, but not limited to, fluoro-acrylate. One non-limiting commercially available fluoro-acrylate that can be used is APG-653.

In yet another and/or additional non-limiting aspect of the present invention, the new solution can include one or more optional ingredients. Non-limiting examples of such optional ingredients include, but are not limited to, emulsifiers, acids, neutralizers (e.g., pH buffers, etc.), surfactants, soil release agents, antistatic agents, fragrance, antimicrobial and/pr preservatives, thickeners, opacifying agents, antioxidants, UV protectors, colorants, etc. Specific examples or the one or more optional ingredients that can be included in the new formulation are listed in the patent and patent publications that are incorporated herein by reference.

In still yet another and/or additional non-limiting aspect of the present invention, the new solution can be applied by conventional means to a surface. Such conventional means include, but are not limited to, a pump sprayer, an aerosol sprayer, etc.

One non-limiting object of the present invention is the provision of a new solution that can be applied to various types of surfaces to inhibit or prevent absorption/adsorption of liquids and/or other types of staining compounds.

Another and/or additional non-limiting object of the present invention is the provision of a new solution that includes nano particles of wax in combination with a non water based solvent.

Still another and/or additional non-limiting object of the present invention is the provision of a new solution that includes nano particles of wax in combination with a liquid repellent agent.

Yet another and/or alternative non-limiting object of the present invention is the provision of a new solution that can be dispensed on a surface by conventional spray mechanisms.

These and other advantages will become apparent to those skilled in the art upon the reading and following of this description.

### DETAILED DESCRIPTION OF THE INVENTION

The present invention relates to a water repellent and/or waterproofing agent, more particularly to a liquid water repellent and/or waterproofing agent that can be applied to various types of surfaces to inhibit or prevent absorption/adsorption of liquids, and even more particularly to a water repellent and/or waterproofing agent that includes nano-sized wax particles to inhibit or prevent absorption/adsorption of liquids on various types of surfaces.

The new solution of the present invention generally includes three components, namely nano particles of wax, solvent and a liquid repellent agent. One non-limiting general formulation of the new solution in weight percent is as follows:

| | |
|---|---|
| Solvent | 75-98%. |
| Liquid repellent agent | 2-15%. |
| Nano particles of wax | 0.05-20%. |

Another non-limiting more specific formulation of the new solution in weight percent is as follows:

| | |
|---|---|
| Solvent | 79-98%. |
| Liquid repellent agent | 3-12%. |
| Nano particles of wax | 0.05-10%. |

Still another non-limiting more specific formulation of the new solution in weight percent is as follows:

| | |
|---|---|
| Solvent | 79-98%. |
| Liquid repellent agent | 1-10%. |
| Nano particles of wax | 0.05-20%. |
| Fragrance | 0-0.5%. |

Yet another non-limiting more specific formulation of the new solution in weight percent is as follows:

| | |
|---|---|
| Solvent | 85-96%. |
| Liquid repellent agent | 1-8%. |
| Nano particles of wax | 0.05-4%. |
| Fragrance | 0-0.5%. |

Still yet another non-limiting more specific formulation of the new solution in weight percent is as follows:

| | |
|---|---|
| Mineral Spirits and/or alcohol | 80-97%. |
| Fluoro hydrophobic polymer | 2-12%. |
| Nano particles of wax | 0.1-18%. |
| Fragrance | 0.01-1%. |

Another non-limiting more specific formulation of the new solution in weight percent is as follows:

| | |
|---|---|
| Mineral Spirits/Isopropyl alcohol | 90-96%. |
| APG-653 | 4-7%. |
| TEGO 105 | 0.06-1%. |
| Sea Breeze Fragrance | 0.01-0.1% |

Still another non-limiting more specific formulation of the new solution in weight percent is as follows:

| | |
|---|---|
| Mineral Spirits/Isopropyl alcohol | 90-95%. |
| APG-653 | 4-6%. |
| TEGO 105 | 0.06-0.3%. |
| Sea Breeze Fragrance | 0.01-0.1%. |

Yet another non-limiting more specific formulation of the new solution in weight percent is as follows:

| | |
|---|---|
| Mineral Spirits/Isopropyl alcohol | 90-96%. |
| APG-653 | 4-7%. |
| TEGO 105 | 0.06-1%. |
| Sea Breeze Fragrance | 0.01-0.1%. |

Still yet another non-limiting more specific formulation of the new solution in weight percent is as follows:

| | |
|---|---|
| Mineral Spirits/Isopropyl alcohol | 93-96%. |
| APG-653 | 4-6%. |
| TEGO 105 | 0.06-0.2%. |
| Sea Breeze Fragrance | 0.02-0.08%. |

In addition to the three primary components of the new solution, the new solution can include one or more additional components such as, but not limited to, emulsifiers, acids, neutralizers (e.g., pH buffers, etc.), surfactants, soil release agents, antistatic agents, fragrance, antimicrobial and/pr preservatives, thickeners, opacifying agents, antioxidants, UV protectors, colorants, etc.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

We claim:

1. A solution for protecting surfaces comprising nano particles of wax, solvent and a liquid repellent agent.

2. The solution as defined in claim 1, wherein said nano particles of wax have an average size of up to about 0.001 micron.

3. The solution as defined in claim 2, wherein said nano particles of wax have an average size of about 0.0000001-0.001 micron.

4. The solution as defined in claim 1, wherein said nano particles of wax constitute up to about 20 weight percent of said solution.

5. The solution as defined in claim 4, wherein said nano particles of wax constitute up to about 20 weight percent of said solution.

6. The solution as defined in claim 1, wherein said solvent constitutes at least a majority of said solution and up to about 98 weight percent of said solution.

7. The solution as defined in claim 5, wherein said solvent constitutes at least a majority of said solution and up to about 98 weight percent of said solution.

8. The solution as defined in claim 1, wherein said solvent includes mineral spirits, alcohol, or mixtures thereof.

9. The solution as defined in claim 7, wherein said solvent includes mineral spirits, alcohol, or mixtures thereof.

10. The solution as defined in claim 1, wherein said liquid repellent agent includes a fluorinated polymer.

11. The solution as defined in claim 9, wherein said liquid repellent agent includes a fluorinated polymer.

12. The solution as defined in claim 11, wherein said fluorinated polymer includes fluoro-acrylate polymer.

13. The solution as defined in claim 1, comprising:

| | |
|---|---|
| Solvent | 75-98% |
| Liquid repellent agent | 2-15% |
| Nano particles of wax | 0.05-20%. |

14. The solution as defined in claim 12, comprising:

| | |
|---|---|
| Solvent | 75-98% |
| Liquid repellent agent | 2-15% |
| Nano particles of wax | 0.05-20%. |

15. The solution as defined in claim 1, comprising:

| | |
|---|---|
| Solvent | 79-98% |
| Liquid repellent agent | 3-12% |
| Nano particles of wax | 0.05-10%. |

16. The solution as defined in claim 12, comprising:

| | |
|---|---|
| Solvent | 79-98% |
| Liquid repellent agent | 3-12% |
| Nano particles of wax | 0.05-10%. |

17. The solution as defined in claim 1, comprising:

| | |
|---|---|
| Solvent | 79-98% |
| Liquid repellent agent | 1-10% |
| Nano particles of wax | 0.05-20% |
| Fragrance | 0-0.5%. |

18. The solution as defined in claim 12, comprising:

| | |
|---|---|
| Solvent | 79-98% |
| Liquid repellent agent | 1-10% |
| Nano particles of wax | 0.05-20% |
| Fragrance | 0-0.5%. |

19. The solution as defined in claim 1, comprising:

| | |
|---|---|
| Solvent | 85-96% |
| Liquid repellent agent | 1-8% |
| Nano particles of wax | 0.05-4% |
| Fragrance | 0-0.5%. |

20. The solution as defined in claim 12, comprising:

| | |
|---|---|
| Solvent | 85-96% |
| Liquid repellent agent | 1-8% |
| Nano particles of wax | 0.05-4% |
| Fragrance | 0-0.5%. |

21. The solution as defined in claim 1, comprising:

| | |
|---|---|
| Mineral Spirits and/or alcohol | 80-97% |
| Fluoro hydrophobic polymer | 2-12% |
| Nano particles of wax | 0.1-18% |
| Fragrance | 0.01-1%. |

22. The solution as defined in claim 12, comprising:

| | |
|---|---|
| Mineral Spirits and/or alcohol | 80-97% |
| Fluoro hydrophobic polymer | 2-12% |
| Nano particles of wax | 0.1-18% |
| Fragrance | 0.01-1%. |

23. The solution as defined in claim 1, comprising:

| | |
|---|---|
| Mineral Spirits/Isopropyl alcohol | 90-96% |
| APG-653 | 4-7% |
| TEGO 105 | 0.06-1% |
| Sea Breeze Fragrance | 0.01-0.1%. |

24. The solution as defined in claim 12, comprising:

| | |
|---|---|
| Mineral Spirits/Isopropyl alcohol | 90-96% |
| APG-653 | 4-7% |
| TEGO 105 | 0.06-1% |
| Sea Breeze Fragrance | 0.01-0.1%. |

25. The solution as defined in claim 1, comprising:

| | |
|---|---|
| Mineral Spirits/Isopropyl alcohol | 90-95% |
| APG-653 | 4-6% |
| TEGO 105 | 0.06-0.3% |
| Sea Breeze Fragrance | 0.01-0.1%. |

26. The solution as defined in claim 12, comprising:

| | |
|---|---|
| Mineral Spirits/Isopropyl alcohol | 90-95% |
| APG-653 | 4-6% |
| TEGO 105 | 0.06-0.3% |
| Sea Breeze Fragrance | 0.01-0.1%. |

27. The solution as defined in claim 1, comprising:

| | |
|---|---|
| Mineral Spirits/Isopropyl alcohol | 90-96% |
| APG-653 | 4-7% |
| TEGO 105 | 0.06-1% |
| Sea Breeze Fragrance | 0.01-0.1%. |

28. The solution as defined in claim 12, comprising:

| | |
|---|---|
| Mineral Spirits/Isopropyl alcohol | 90-96% |
| APG-653 | 4-7% |
| TEGO 105 | 0.06-1% |
| Sea Breeze Fragrance | 0.01-0.1%. |

29. The solution as defined in claim 1, comprising:

| | |
|---|---|
| Mineral Spirits/Isopropyl alcohol | 93-96% |
| APG-653 | 4-6% |
| TEGO 105 | 0.06-0.2% |
| Sea Breeze Fragrance | 0.02-0.08%. |

30. The solution as defined in claim 12, comprising:

| | |
|---|---|
| Mineral Spirits/Isopropyl alcohol | 93-96% |
| APG-653 | 4-6% |
| TEGO 105 | 0.06-0.2% |
| Sea Breeze Fragrance | 0.02-0.08%. |
